(19) United States
(12) Patent Application Publication
(10) Pub. No.: US 2026/0195112 A1
(43) Pub. Date: Jul. 9, 2026

(54) USER PERMISSIONS FOR CONTAINER DEPLOYMENT AND MANAGEMENT

(71) Applicant: International Business Machines Corporation, Armonk, NY (US)

(72) Inventors: Juliet Candee, Brewster, NY (US); Xiao Ling Chen, Beijing (CN); Yuan Li, Beijing (CN); Heng Wang, Beijing (CN); Si Yu Chen, Beijing (CN)

(21) Appl. No.: 19/008,768

(22) Filed: Jan. 3, 2025

(51) Int. Cl. G06F 8/61; G06F 9/455; G06F 21/62

(52) U.S. Cl. CPC G06F 8/63; G06F 9/45558; G06F 21/62; G06F 2009/45562; G06F 2221/2141

(57) ABSTRACT

A computer-implemented method includes receiving a request from a user, the request being one of a first request to push an image layer of a container from a local graph to an image repository or a second request to pull an image layer of a container image from the image repository to the local graph. The method further includes identifying permissions associated with the user and determining whether the permissions associated with the user authorize the user to perform an action associated with the request. The method further includes, responsive to determining that the permissions associated with the user authorize the user to perform the action associated with the request, performing the action, the action being one of pushing the image layer of the container from the local graph to the image repository or pulling the image layer of the container image from the image repository to the local graph.

### BACKGROUND

The present disclosure relates to computing systems, and more specifically, to user permissions for container deployment and management.

Containers provide an application layer approach to virtualization. A container packages together code and its dependencies, and the container can be run on a physical processing system. Multiple containers can be run on the same physical processing system. This approach uses less resources than a virtual machine approach to virtualization.

### SUMMARY

According to an embodiment, a computer-implemented method is provided. The method includes receiving a request from a user, the request being one of a first request to push an image layer of a container from a local graph to an image repository or a second request to pull an image layer of a container image from the image repository to the local graph. The method further includes identifying permissions associated with the user, the permissions being defined in metadata of a manifest config item of the image layer of the container executing based on the container image. The method further includes determining whether the permissions associated with the user authorize the user to perform an action associated with the request. The method further includes, responsive to determining that the permissions associated with the user authorize the user to perform the action associated with the request, performing the action, the action being one of pushing the image layer of the container from the local graph to the image repository or pulling the image layer of the container image from the image repository to the local graph.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment according to an embodiment;

FIG. 2 illustrates an image and a container, each with layers according to an embodiment;

FIG. 3 illustrates a block diagram of a system for implementing user permissions for container deployment and management, according to an embodiment;

FIG. 4 depicts a block diagram of a system for implementing user permissions for container deployment and management according to an embodiment;

FIGS. 5A and 5B depict various scenarios for user permissions for container deployment and management according to an embodiment;

FIG. 6 depicts an example of generating a manifest config layer permission ID according to an embodiment;

FIG. 7 depicts a manifest config item according to an embodiment;

FIG. 8 depicts a block diagram of an implementation of the manifest-based configure for layer staging permission consumer engine of FIG. 1 according to an embodiment;

FIG. 9A illustrates a flow diagram of a method for a flow diagram of a method for implementing user permissions for container deployment and management using the manifest-based config for layer staging permission producer engine of FIG. 1 according to an embodiment;

FIG. 9B illustrates a flow diagram of a method for a flow diagram of a method for implementing user permissions for container deployment and management using the manifest-based config for layer staging permission consumer engine of FIG. 1 according to an embodiment; and

FIG. 10 illustrates a flow diagram of a method for implementing user permissions for container deployment and management according to an embodiment.

The detailed description explains embodiments of the disclosure, together with advantages and features, by way of example with reference to the drawings.

### DETAILED DESCRIPTION

One or more embodiments described herein relate to user permissions for container deployment and management.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

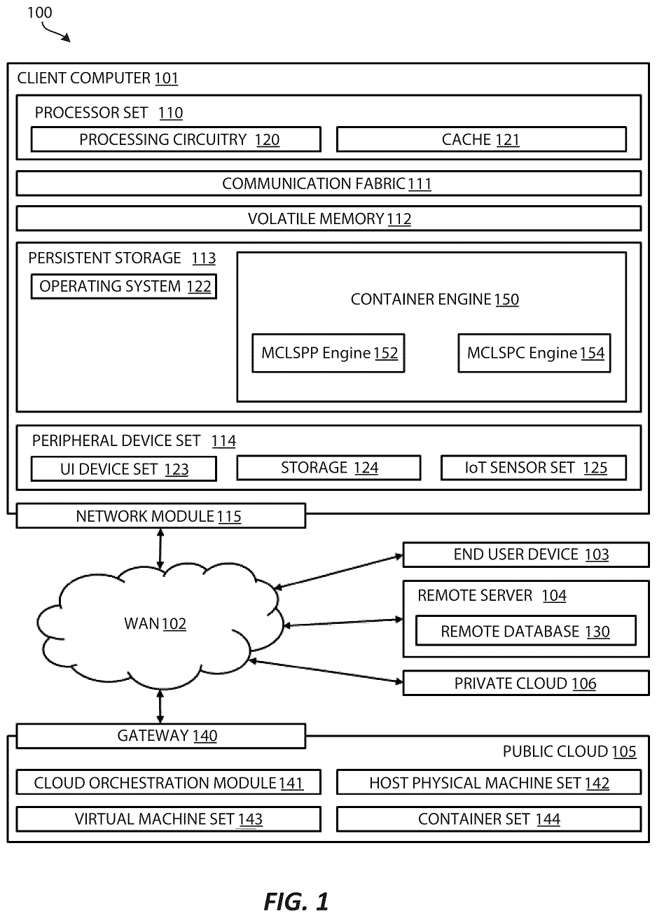

FIG. 1 illustrates a computing environment 100, according to an embodiment. Computing environment 100 contains an example of an environment for the execution of at least some of the computer code involved in performing the inventive methods, such as a container engine 150, which may be used for container deployment and management. The container engine 150 may include a manifest-based config for layer staging permission producer engine (MCLSPP) and/or a manifest-based config layer staging permission consumer engine (MCLSPC) 154. In addition to container engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and container engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in container engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in container engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Containers package together code and its dependencies to provide for virtualization. Some approaches to implementing containers involve packaging the contents of image layers into an image and pushing the image to an image repository. The container image can then be pulled from the image repository to be implemented on other systems, such as by end users. When pulling a container image from the image repository, the contents of the image layers and any parent layers for the container image are downloaded to a local graph. Once downloaded, the container image can be stored on a local graph and deployed as a container. In other words, the layers of the container image are uploaded to the image repository and then those layers are later downloaded to one or more local graphs for deployment as a container.

In some cases, after a product (e.g., container) is release, a service provider or customer may desire to add permission management. Some existing approaches to container deployment and management prevent a running container from being modified or extended in an unauthorized manner based on the image layer staging operation permission of a user group by changing layer metadata with new attributes. However, such approaches are insufficient where layer metadata can only be updated before a container image is pushed to the image repository.

One or more embodiments described herein address these and other shortcomings by providing user permissions for container deployment and management. More particularly, one or more embodiments enables container exploitation in large-scale projects in a secure and flexible manner to avoid container image or specific layer downloading the image layer and updating the group permission by an unexpected user without proper permissions after the image layer is pushed to the image repository.

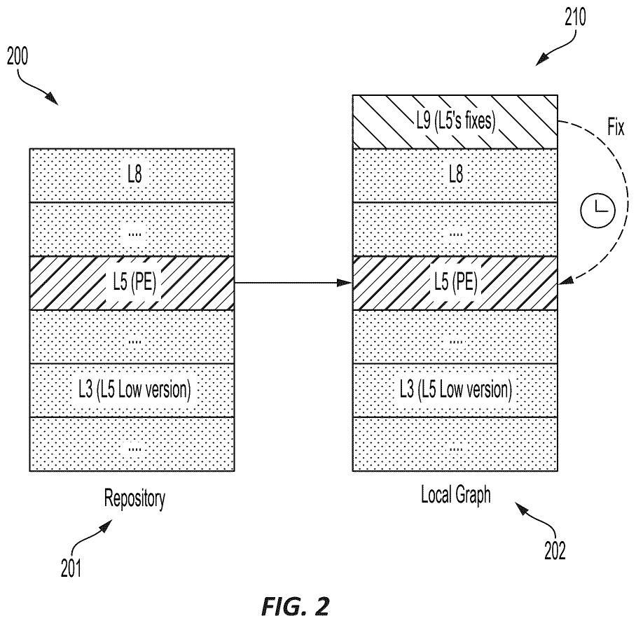

Turning now to FIG. 2, a container image 200 and a container 210, each with layers, are shown, according to an embodiment. The container image 200 is stored in an image repository 201 and can be downloaded to and installed on a local graph 202 as the container 210. In FIG. 2, the container image 200 and the container 210 are shown as having multiple layers, including layers L3, L5, and L8, among others.

A container image (e.g., the container image 200) is a standalone executable software package that includes the information needed to run a piece of software, including the code, runtime, system tools, libraries, and settings. Container images are used to create containers, which are instances of the container images running as isolated processing on a host operating system (e.g., the operating system 122). For example, the container image 200 is used to create the container 210. According to an embodiment, the container 210 is a container image pulled from the image repository 201 to the local graph 202. According to another embodiment, consider the following example. Docker mounts layers (e.g., a base layer, layer L1, . . . Layer L7, Layer L8) at one mount point. These are called image layers, and the container 210 exploited with this image can share the image layers (e.g., read-only layers) and have their own container layer (read-write layer). For example, Docker runs three containers C1, C2, C3 with image I1, then the containers C1, C2, C3 share the image layers of I1, which is stored in local graph 202 as the container 210 shown. If a patch in error (PE) is deployed to one of the layers (e.g., to the layer L5 as shown in FIG. 2), a new fix for the PE can be implemented as a new layer of the container 210 of FIG. 2 (e.g., layer L9, which represents L5's fixes).

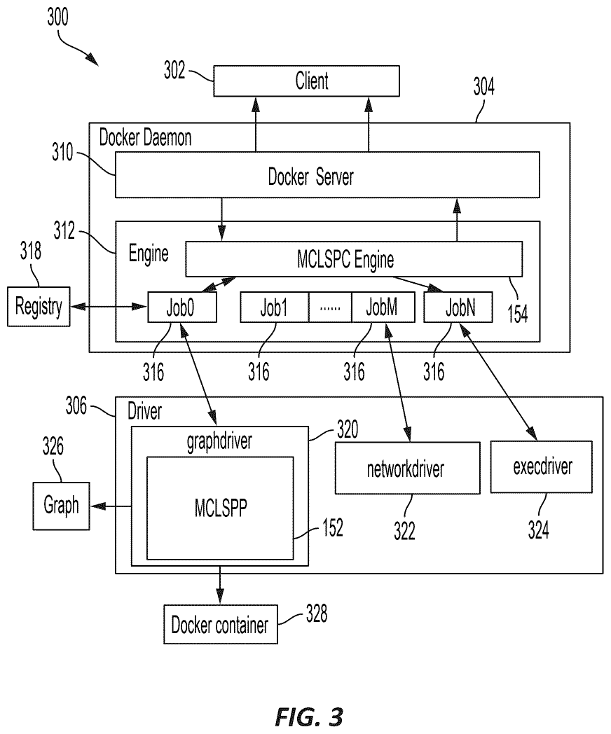

FIG. 3 illustrates a block diagram of a system 300 for implementing user permissions for container deployment and management according to an embodiment. The system 300 includes several components that work together to implement user permissions for container deployment and management, including the MCLSPP engine 152 and the MCLSPC engine 154. For example, the system 300 provides for defining different permissions for different types/classes of users. One such example is as follows: a non-developer user has no push or pull permission, meaning that the user cannot push or pull container images to an image repository; a superuser has both push and pull permission; an end-user has pull-only permission (no push permission); and a system administrator has push-only permission (no pull permission). It should be appreciated that other types/classes of users and/or other arrangements of permissions may be possible in other examples.

The system 300 includes a client 302 in combination with a docker daemon 304, which in turn is in communication with a driver. The client 302 can send commands to a docker server 310 of the docker daemon 304.

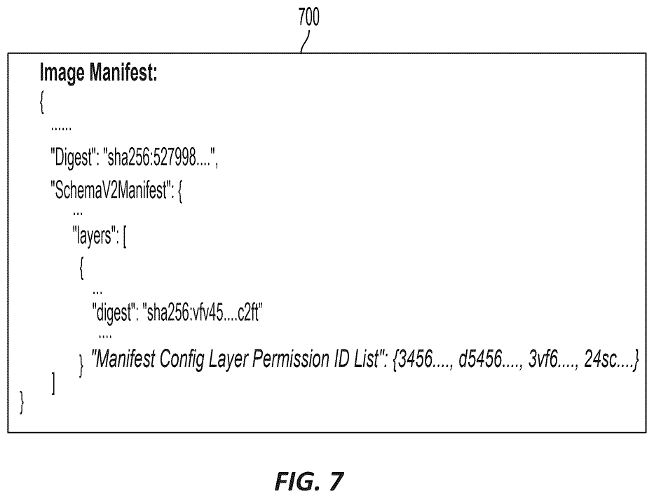

The docker daemon 304 includes the docker server 310 and an engine 312. The docker server 310 processes the command(s) from the client 302 (e.g., user) and interacts with the engine 312. The engine 312 includes the MCLSPC engine 154, which is responsible determining whether the client 302 has user group permissions to execute the container image (e.g., container image 200) pulling from the image repository (e.g., image repository 201) or updating layer user group permission settings to the image repository (e.g., image repository 201) according to a “Manifest Config Layer Permission ID” of the layer manifest config item and user's group permission. The “Manifest Config Layer Permission ID” (MCLPID) is used to record a setting of the user group's layer staging operation permission assigned to the different user groups. This includes container image pulling from the image repository and pushing layer user group permission settings to the image repository after the container image or layer is delivered. The MCLPID is calculated using a layer's imageID and manifest config layer permission code. The manifest config layer permission code a table, link, or other object to describe whether the user group has the permission of pulling image from the repository or push a new lawyer/image to the repository (e.g., “1” for has the permission, “0” for does not have the permission). Each layer in a container image has its own unique identifier (e.g., a SHA256 hash), which is the layer's imageID. This identifier is generated based on the contents of the layer, ensuring that even small changes in the layer will result in a different ID. A “Manifest Config Layer Permission ID List” (MCLPID List) is added to the image layer's manifest config item (see FIG. 7) to store user groups'permission settings about container image pulling from the image repository and updating layer user group permission settings to the image repository.

The engine 312 also manages various jobs 316 (Job0, Job2, . . . , JobM, JobN) that are executed as part of the renewal process. The jobs 316 interact with registry 318 stores the container images and layers.

The driver 306 includes various sub-drivers, including graphdriver 320, networkdriver 322, and execdriver 324, which are responsible for managing different aspects of the container's operation. More particularly, graphdriver 320 manages the storage and retrieval of the container's layers in the local graph 326, networkdriver 322 manages the network aspects of the container, and execdriver 324 manages the execution of processes within the container. Graphdriver 320 also includes the MCLSPP engine 152 according to one or more embodiments. The MCLSPP engine 152 is used to determine whether the client 302 (e.g., user) has user group permission to execute the container image pulling from the image repository or updating layer user group permission settings to the image repository according to MCLPID of the layer manifest config item and user's group permission.

Local graph 326 represents a local graph (e.g., local graph 202), which stores the container's layers and their metadata locally.

Docker container 328 is an example of the container 210 and represents is the running instance of the container image 200, which includes the layers being managed and renewed by the system.

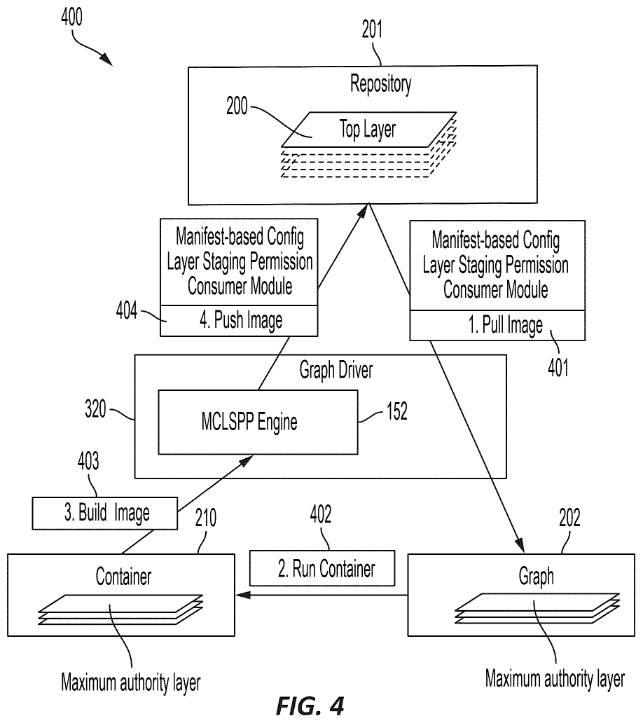

FIG. 4 depicts a block diagram of a system 400 for implementing user permissions for container deployment and management according to an embodiment. The system 400 includes several components that work together to manage and enforce user permissions for container image layers. Such components include the image repository 201, local graph 202, the container image 200, the container 210, the graphdriver 320, and the MCLSPP engine 152.

At block 401, a layer (or layers) of the container image 200 is pulled from the image repository 201 to the local graph 202 via the graphdriver 320. The MCLSPC engine 154 (shown in FIG. 1) checks the user's permissions before allowing the pull operation.

At block 402, the container 210 is run using the layer(s) pulled from the image repository 201 and stored at the local graph 202. The container 210 is executed based on the permissions and configurations set by the system 400.

At block 403, a new container image is built from the layers stored in the local graph 202 for the container 210. The new container image can then be pushed to the image repository 201 at block 404.

Particularly, at block 404, an image layer for the new container image is pushed to the image repository 201 using the MCLSPP engine 152 and the graphdriver 320. The MCLSPP engine 152 checks the user's permissions before allowing the push operation.

The system 400 depicted in FIG. 4 illustrates the process of managing user permissions for container deployment and management. The system 400 ensures that authorized users can push or pull image layers to and from the image repository 201, thereby enhancing the security and flexibility of container management in large-scale projects. The use of the MCLSPP engine 152 and MCLSPC engine 154 provides for granular control over user permissions, ensuring that the system 400 operates securely and efficiently.

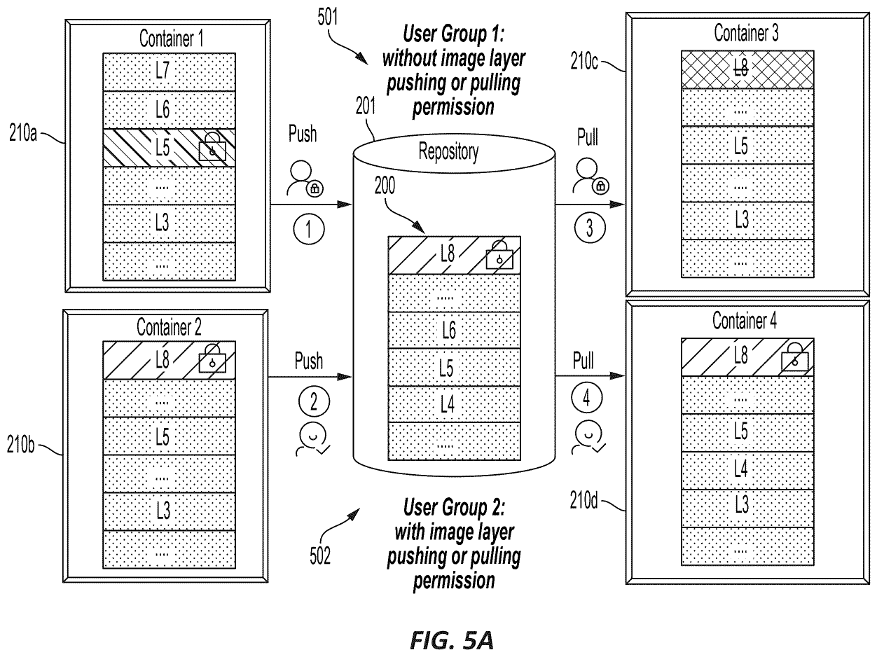

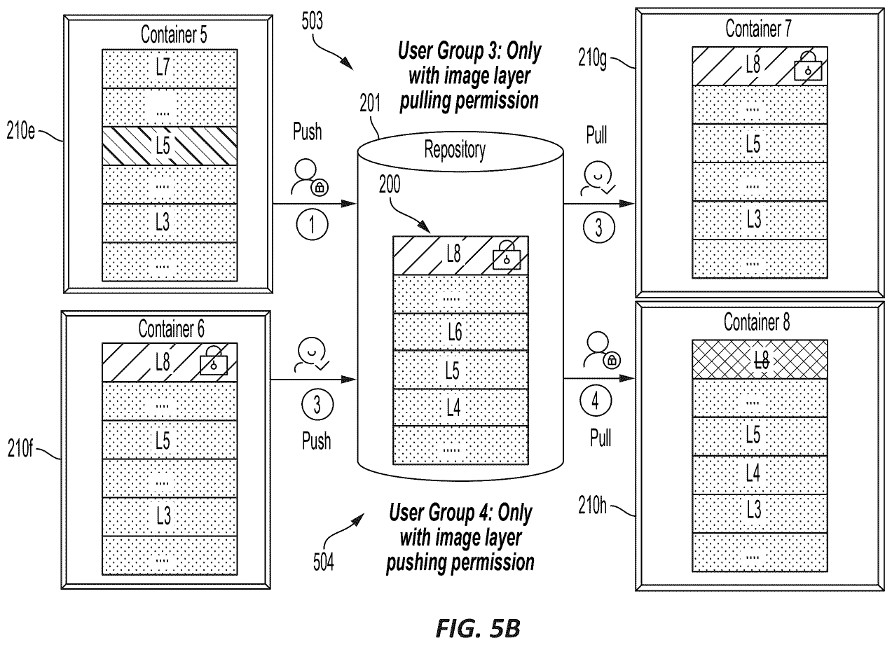

FIGS. 5A and 5B depict various scenarios for user permissions for container deployment and management according to an embodiment. In the examples of FIGS. 5A and 5B, different permissions are defined for different types/classes of users. One such example is as follows: a non-developer user (user group 1 501 of FIG. 5A) has no push or pull permission, meaning that the user cannot push to or pull image layers from an image repository; a superuser (user group 2 502 of FIG. 5A) has both push and pull permission; an end-user (user group 3 503 of FIG. 5B) has pull-only permission (no push permission); and a system administrator (user group 4 504 of FIG. 5B) has push-only permission (no pull permission). It should be appreciated that other types/classes of users and/or other arrangements of permissions may be possible in other examples.

With reference to FIG. 5A, user group 1 501 is now described in more detail. A user of the user group 1 501 attempts to push a layer (L5) of container 210a to the image repository 201 and to pull a layer (L8) of container image 200 from the image repository 201 to container 210c. However, both the pull action and the pull action are prevented because the user does not have sufficient permissions. Namely, the user of the user group 1 501 has no push or pull permission, meaning that the user cannot push to or pull image layers from the image repository 201.

With continued reference to FIG. 5A user group 2 502 is now described in more detail. A user of the user group 2 502 attempts to push a layer (L8) of container 210b to the image repository 201 and to pull a layer (L8) of container image 200 from the image repository 201 to container 210d. Both the pull action and the pull action are allowed because the user has both push and pull permission.

Turning now to FIG. 5B, user group 3 503 is now described in more detail. A user of the user group 3 503 attempts to push a layer (L5) of container 210e to the image repository 201 and to pull a layer (L8) of container image 200 from the image repository 201 to container 210g. In this scenario, the pull action is allowed while the push action is prevented because the user of the user group 3 503 has pull permission but no push permission, meaning that the user can pull from but cannot push image layers to the image repository 201.

With continued reference to FIG. 5B, user group 4 504 is now described in more detail. A user of the user group 4 504 attempts to push a layer (L8) of container 210f to the image repository 201 and to pull a layer (L8) of container image 200 from the image repository 201 to container 210h. In this scenario, the push action is allowed while the pull action is prevented because the user of the user group 4 504 has push permission but no pull permission, meaning that the user can push to but cannot pull image layers from the image repository 201.

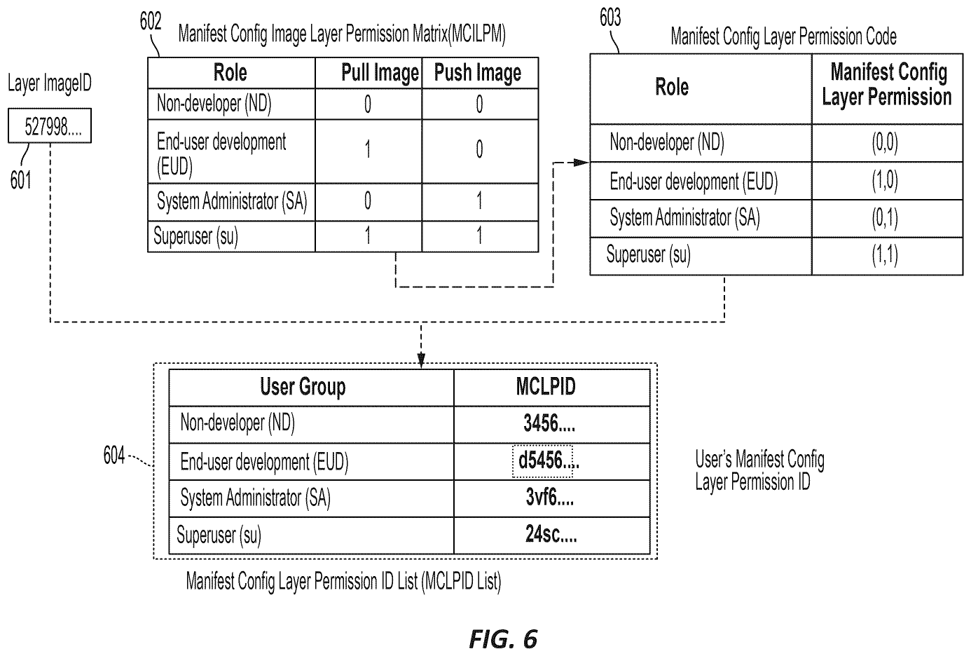

FIG. 6 depicts an example of generating a manifest config layer permission ID according to an embodiment. The figure includes Layer ImageID 601, manifest config image layer permission matrix (MCILPM) 602, manifest config layer permission code (MCLPC) 603, and MCLPID List 604.

Layer ImageID 601 represents an identifier for a specific layer of a container image. This identifier is used to track and manage the layer within the container management system.

MCILPM 602 defines the permissions for different user roles regarding pulling and pushing image layers. The matrix includes roles such as non-developer (ND), end-user development (EUD), system administrator (SA), and superuser (su), each with specific permissions for pulling and pushing images.

MCLPC 603 provides a code that corresponds to the permissions defined in the MCILPM 602. This code is used to determine the specific permissions assigned to each user role for a given layer.

Together, the layer imageID 601, MCILPM 602, and MCLPC 603 are used to determine the manifest config layer permission ID, which is calculated as the hash of the sum of the layer imageID 601 and the MCLPC 603. The resulting manifest config layer permission ID is stored in the MCLPID List 604, which stores the manifest config layer permission IDs for different user groups as shown. MCLPID List 604 includes the user groups and their corresponding MCLPIDs, which are used to enforce the permissions for pulling and pushing image layers.

FIG. 6 illustrates the interaction between these components, showing how the Layer imageID 601, MCILPM 602, MCLPC 603, and MCLPID List 604 work together to manage and enforce user permissions for container image layers.

FIG. 7 depicts a manifest config item 700 according to an embodiment. The manifest config item 700 includes unique digests for a layer of a container image, including permissions for different user groups. This detailed metadata ensures that the layers of a container image can be securely managed and deployed, with granular control over user permissions. The manifest config item 700 includes the MCLPID List, which stores user groups'permission settings about container image pulling from the image repository and updating layer user group permission settings to the image repository. The use of the MCLPID List allows for precise enforcement of permissions, enhancing the security and flexibility of container deployment and management in large-scale projects.

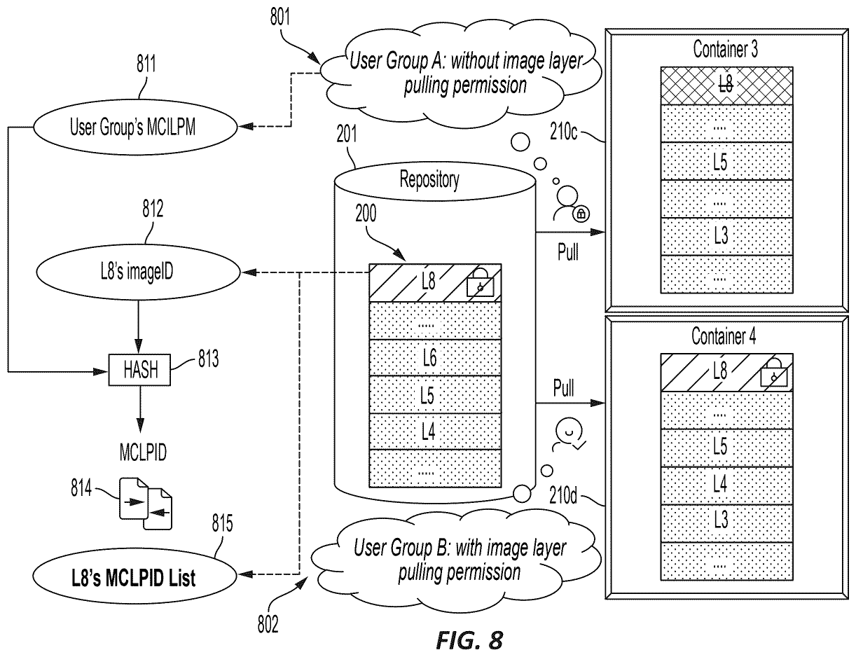

FIG. 8 depicts a block diagram of an implementation of the MCLSPC engine 154 of FIG. 1 according to an embodiment. This embodiment involves generating a unique MCLPID for each user group based on the layer's imageID and the permission code, and then verifying the MCLPID against the MCLPID List associated with the layer. This ensures that authorized users can perform actions (e.g., pull or push image layers) while preventing unauthorized users from performing such actions, enhancing the security and flexibility of container deployment and management in large-scale projects. The figure demonstrates both successful and unsuccessful attempts to pull layer L8 by different user groups, highlighting the effectiveness of the permission management system.

Particularly, two user groups are provided: user group A 801 (without image layer pulling permission) and user group B 802 (with image layer pulling permission). That is, user group A 801 users are prevented from pulling an image layer from container 210c while user group B 802 users are authorized to pull an image layer from container 210d from the layers of the container image 200 of the image repository 201.

User group's MCILPM 811 represents the manifest config image layer permission matrix for a user group, namely the user group A 801. The MCILPM defines the permissions for different user groups, such as whether they can pull or push image layers.

Layer 8's imageID 812 is the unique identifier for Layer 8 (L8) of the container image 200. The imageID is used in conjunction with the manifest config layer permission code to generate the MCLPID.

User group's MCILPM 811 is added to the image ID 812 and hashed 813 to generate MCLPID 814 as described herein. The MCLPID 814 is used to verify whether a user has the requisite permissions to pull the layer L8 from the container image of the image repository 201. The MCLPID 814 is added to the MCLPID list 815 for L8. More particularly, MCLPID list 815 stores the MCLPIDs for different user groups (e.g., user group A 801 and user group B 802). The MCLPID List 815 is associated with the layer L8 and defines the permissions for various user groups to pull the layer from the image repository 201.

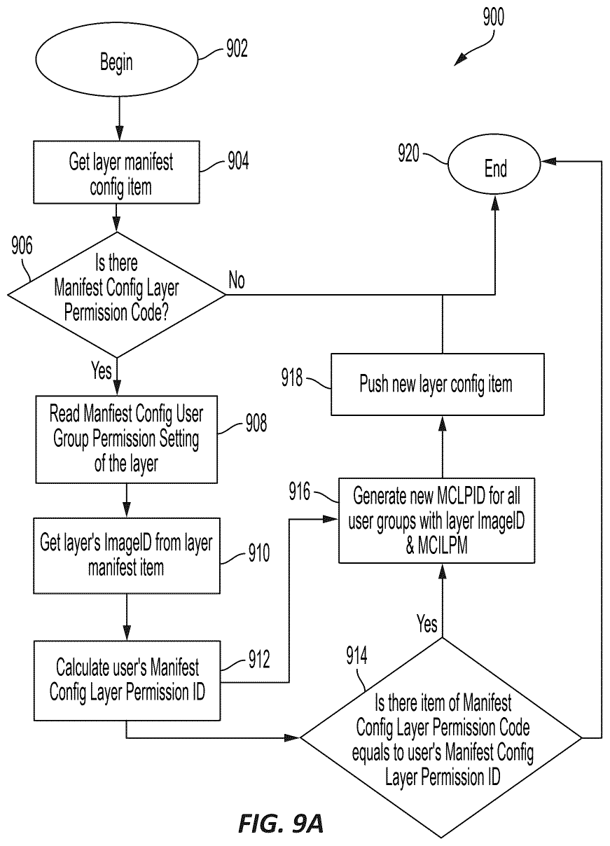

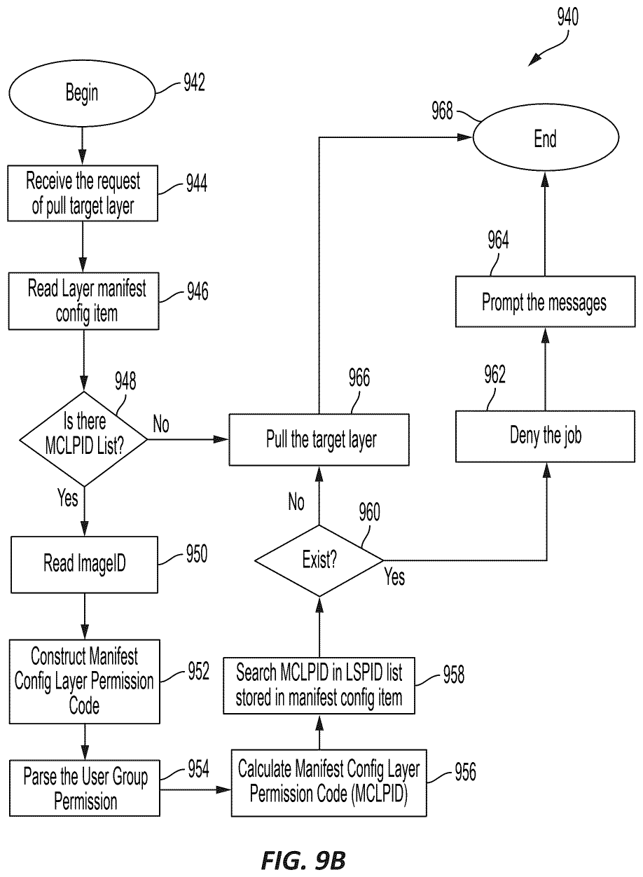

Turning now to FIG. 9A, a flow diagram of a method 900 for implementing user permissions for container deployment and management using the MCLSPP engine 152 is provided according to an embodiment. The method 900 can be performed by any suitable computing system, device, or environment, such as those described herein (e.g., the computing environment 100 and/or the computer 101 of FIG. 1). According to one or more embodiments, the method 900 is performed, in whole or in part, using container engine 150 (including the MCLSPP engine 152) of FIG. 1.

The method 900 begins at block 902, which represents the initial step in the method 900 for implementing user permissions for container deployment and management using the MCLSPP engine 152. The initiation of the process involves setting up the environment and parameters for the subsequent steps. This may include initializing variables, establishing connections to resources, such as the image repository 201, and preparing the system to handle incoming requests from users.

Block 904 involves getting the layer manifest config item from the repository. This step retrieves the manifest configuration data associated with the target layer. The manifest config item contains metadata and other relevant information about the layer, which is used for determining user permissions and other operations.

Block 906 checks if there is a manifest config layer permission code associated with the layer. This step involves determining whether the retrieved manifest config item includes a configuration file or table that specifies the permission settings for the layer. If such a code exists, the method 900 proceeds to block 908. If not, the method 900 proceeds to block 920 and ends.

Block 908 reads the manifest config user group permission setting of the layer from the manifest config item. This step involves extracting the user group permission settings from the manifest config item. These settings define the permissions assigned to different user groups for the layer, such as whether types/classes of users can push or pull the layer.

Block 910 retrieves the layer's imageID from the manifest config item. The imageID is a unique identifier for the layer, which is used in subsequent steps to calculate the user's manifest config layer permission ID.

Block 912 calculates the user's manifest config layer permission ID. This step involves using the layer's imageID and the current user's MCLPC to generate a unique permission ID for the user. The permission ID is used to verify whether the user has the requisite permissions to perform the requested action.

Block 914 checks if there is an item of manifest config layer permission code that equals the user's manifest config layer permission ID. This step involves searching the manifest config item for a permission code that matches the calculated permission ID. If a matching code is found, the method 900 proceeds to block 916. If not, the method 900 proceeds to block 920 and ends.

Block 916 generates a new MCLPID for user groups with the layer's imageID and a manifest config image layer permission matrix (see FIG. 6). This step involves creating a new list of permission IDs for user groups based on the layer's ImageID and the MCILPM. This list is used to update the manifest config item with the latest permission settings.

Block 918 pushes the new layer config item to the repository. This step involves updating the repository with the new manifest config item that includes the updated permission settings. This ensures that the latest permissions are enforced for the layer.

The method 900 ends at block 920, where the method 900 is completed. This block represents the final step in the method 900, where the system wraps up any remaining tasks, such as logging the action, updating records, or cleaning up resources. The completion of the method 900 ensures that the system is ready to handle new requests and maintain the operational state.

Additional processes also may be included, and it should be understood that the processes depicted in FIG. 9A represent illustrations, and that other processes may be added or existing processes may be removed, modified, or rearranged without departing from the scope of the present disclosure. It should also be understood that the processes depicted in FIG. 9A may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

Turning now to FIG. 9B, a flow diagram of a method 940 for implementing user permissions for container deployment and management using the MCLSPC engine 154 is provided according to an embodiment. The method 940 can be performed by any suitable computing system, device, or environment, such as those described herein (e.g., the computing environment 100 and/or the computer 101 of FIG. 1). According to one or more embodiments, the method 900 is performed, in whole or in part, using container engine 150 (including the MCLSPC engine 154) of FIG. 1.

The method 940 begins at block 942, which represents the initial step in the method 940 for implementing user permissions for container deployment and management using the MCLSPC engine 154. The initiation of the process involves setting up the environment and parameters for the subsequent steps. This may include initializing variables, establishing connections to resources, such as the image repository 201, and preparing the system to handle incoming requests from users.

Block 944 involves receiving the request to pull the target layer. This step captures the user's intent to pull a specific layer of a container image from the image repository. The request is typically received through an interface or API that allows users to interact with the container management system.

Block 946 involves reading the layer manifest config item from the repository. This step retrieves the manifest configuration data associated with the target layer. The manifest config item contains metadata and other relevant information about the layer, which is used for determining user permissions and other operations.

Block 948 checks if there is a MCLPID List associated with the layer. This step involves determining whether the retrieved manifest config item includes a list that specifies the permission settings for the layer. If such a list exists, the method 940 proceeds to block 950. If not, the method 940 proceeds to block 966, where the target layer is pulled.

Block 950 involves reading the imageID of the target layer. The imageID is a unique identifier for the layer, which is used in subsequent steps to calculate the user's manifest config layer permission ID.

Block 952 constructs the manifest config layer permission code based on the current user's user group permission. This step involves generating a permission code that reflects the user's permissions for the layer, such as whether the user can push or pull the layer.

Block 954 parses the user group permission assigned to the user. This step involves extracting the specific permissions assigned to the user group to which the user belongs. These permissions dictate what actions the user is authorized to perform on the layer.

Block 956 calculates the MCLPID. This step involves using the layer's imageID and the constructed manifest config layer permission code to generate a unique permission ID for the user. The permission ID is used to verify whether the user has the necessary permissions to perform the requested action.

Block 958 searches the MCLPID in the MCLPID list stored in the manifest config item. This step involves looking for the permission ID in the list of permission IDs stored in the manifest config item.

Block 960 checks if the MCLPID exists in the MCLPID list. This step involves verifying whether the calculated permission ID is present in the list of permission IDs. If the ID exists, the method 940 proceeds to block 962. If not, the process proceeds to block 966.

Block 962 involves denying the job responsive to the permission ID not being present in the list of permission IDs. That is, if the user's permissions do not authorize the user to perform the requested action, the system denies the request. This step enforces security policies and ensures that users cannot perform restricted actions for which the user does not have adequate permission.

Block 964 prompts the messages about the job denial. This step involves providing feedback or an error message to the user, indicating that the action is not permitted due to insufficient user permissions.

Block 966 involves pulling the target layer. If the user's permissions authorize them to perform the requested action, the system proceeds to pull the target layer from the image repository to the local graph. This step involves executing the necessary operations to complete the requested action, such as transferring data between the local graph and the image repository.

The method 940 ends at block 968, where the method 940 is completed. This block represents the final step in the method 940, where the system wraps up any remaining tasks, such as logging the action, updating records, or cleaning up resources. The completion of the method 940 ensures that the system is ready to handle new requests and maintain the operational state.

Additional processes also may be included, and it should be understood that the processes depicted in FIG. 9B represent illustrations, and that other processes may be added or existing processes may be removed, modified, or rearranged without departing from the scope of the present disclosure. It should also be understood that the processes depicted in FIG. 9B may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

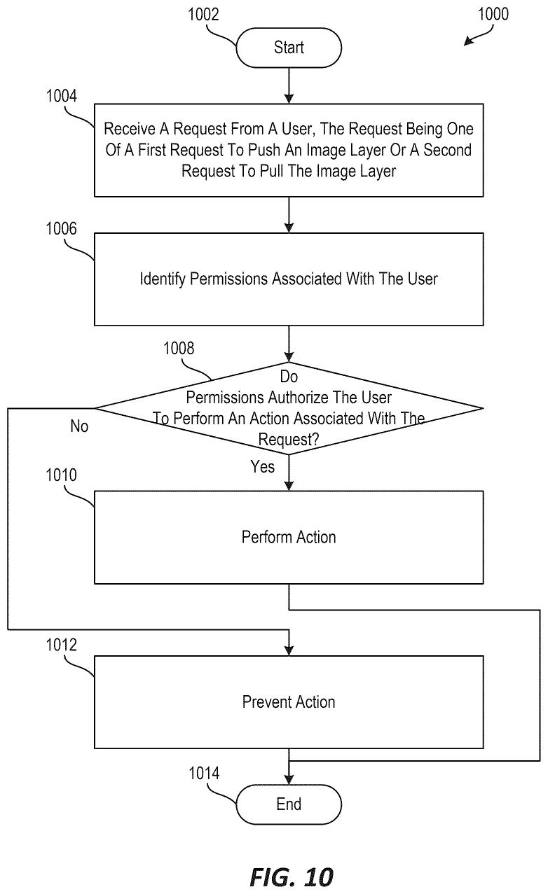

Turning now to FIG. 10, a flow diagram of a method 1000 for implementing user permissions for container deployment and management is provided according to an embodiment. The method 1000 can be performed by any suitable computing system, device, or environment, such as those described herein (e.g., the computing environment 100 and/or the computer 101 of FIG. 1). According to one or more embodiments, the method 900 is performed, in whole or in part, using container engine 150 (including the MCLSPP engine 152 and/or the MCLSPC engine 154) of FIG. 1.

The method 1000 begins at block 1002, where the process starts. This block represents the initial step in the method 1000 for implementing user permissions for container deployment and management. The initiation of the method 1000 involves setting up the environment and parameters for the subsequent blocks shown in FIG. 10. This may include initializing variables, establishing connections to resources, such as the image repository 201 and local graph 202, and preparing the system to handle incoming requests from users.

Block 1004 involves receiving a request from a user, such as via the client 302. The request can be one of a first request to push an image layer of a container (e.g., container 210) from a local graph (e.g., local graph 202) to an image repository (e.g., image repository 201) or a second request to pull an image layer of a container image (e.g., container image 200) from the image repository (e.g., image repository 201) to the local graph(e.g., local graph 202) . This step captures the user's intent and the specific action the user wishes to perform. The request may be received through an interface or application programming interface (API) that allows users to interact with the container management system.

Block 1006 focuses on identifying permissions associated with the user. The permissions are defined in metadata of the image layer of the container executing based on the container image. For example, the MCLPID as described herein is an example of metadata and is used to record a setting of the user group's layer staging operation permission assigned to the different user groups. This step involves querying the metadata to retrieve the user's permissions, which dictate what actions the user is authorized to perform. The metadata may include information such as user roles, permission levels, and specific permissions related to pushing or pulling image layers. The system accurately identifies these permissions to ensure that prevent actions that the user is not authorized to perform.

Block 1008 entails determining whether the permissions associated with the user authorize the user to perform an action associated with the request. This step involves evaluating the identified permissions against the requested action. The system checks if the user has the requisite permissions to either push the image layer to the image repository or pull the image layer from the image repository. This determination provides for maintaining the security and integrity of the container management system, ensuring that users cannot perform unauthorized actions.

Block 1010 is executed responsive to determining that the permissions associated with the user authorize the user to perform the action associated with the request. If the user is authorized, the system proceeds to perform the action, which can be either pushing the image layer of the container from the local graph to the image repository or pulling the image layer of the container image from the image repository to the local graph depending on the request. This step involves executing the operations to complete the requested action (e.g., push or pull), such as transferring data between the local graph and the image repository.

Block 1012 involves preventing the action from being performed if the permissions associated with the user do not authorize the user to perform the action associated with the request. This step enforces security policies and ensures that authorized users can perform certain actions. If the user lacks the appropriate permissions to perform an action that the user requests, the system denies the request and may provide feedback or an error message to the user, indicating that the action is not permitted.

The method 1000 ends at block 1014, where the method 1000 is completed. This block represents the final step in the method, where the system wraps up any remaining tasks, such as logging the action, updating records, or cleaning up resources. The completion of the method ensures that the system is ready to handle new requests and maintain the operational state.

Additional processes also may be included, and it should be understood that the processes depicted in FIG. 10 represent illustrations, and that other processes may be added or existing processes may be removed, modified, or rearranged without departing from the scope of the present disclosure. It should also be understood that the processes depicted in FIG. 10 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

One or more embodiments described herein improve the functioning of a computer by enhancing the security and flexibility of container deployment and management in large-scale projects. Specifically, one or more embodiments provide one or more of the following improvements.

One or more embodiments provide granular permission control. By introducing the manifest config layer permission ID and the manifest config layer permission ID list, one or more embodiments allows for more granular control over user permissions. This means that permissions can be assigned at the layer level on a per-user basis, rather than at the container level, providing more precise control over who can push or pull specific layers of a container image.

One or more embodiments provide post-release permission management. For example, one or more embodiments enables the updating of user permissions even after a container image has been pushed to the image repository. This is achieved by updating the manifest config list on the image repository with the MCLPID List. This capability is particularly useful for maintaining security and compliance in dynamic environments where user roles and permissions may change over time.

One or more embodiments provide enhanced security. By ensuring that authorized users can push or pull image layers based on their permissions, one or more embodiments reduces the risk of unauthorized modifications or access to container images. This helps in preventing security vulnerabilities and potential breaches.

One or more embodiments provide automation and resiliency. For example, one or more embodiments automates the process of checking and enforcing user permissions, which reduces the manual effort required for permission management. This automation also enhances the resiliency of the system by ensuring that permission checks are consistently applied, reducing the likelihood of error.

One or more embodiments provide compatibility with existing tools. For example, one or more embodiments is compatible with existing container tools. This means that the improvements can be integrated into existing workflows without significant changes to the underlying infrastructure.

One or more embodiments provide transparency. For example, one or more embodiments is transparent to both the developers of the image and the end users. This means that the permission management process does not interfere with the normal operations of container deployment and management, providing a seamless experience for users.

By implementing these improvements, the embodiments described herein enhance the overall security, flexibility, and efficiency of container deployment and management, thereby improving the functioning of a computer system in handling containerized applications.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
receiving a request from a user, the request being one of a first request to push an image layer of a container from a local graph to an image repository or a second request to pull an image layer of a container image from the image repository to the local graph;
identifying permissions associated with the user, the permissions being defined in metadata of a manifest config item of the image layer of the container executing based on the container image;
determining whether the permissions associated with the user authorize the user to perform an action associated with the request; and
responsive to determining that the permissions associated with the user authorize the user to perform the action associated with the request, performing the action, the action being one of pushing the image layer of the container from the local graph to the image repository or pulling the image layer of the container image from the image repository to the local graph.

2. The computer-implemented method of claim 1, further comprising, responsive to determining that the permissions associated with the user do not authorize the user to perform the action associated with the request, preventing the action from being performed.

3. The computer-implemented method of claim 1, wherein the user is authorized to perform a push action to push the image layer of the container from the local graph to the image repository and to perform a pull action to pull the image layer of the container image from the image repository to the local graph.

4. The computer-implemented method of claim 1, wherein the user is authorized to perform a push action to push the image layer of the container from the local graph to the image repository but is not authorized to perform a pull action to pull the image layer of the container image from the image repository to the local graph.

5. The computer-implemented method of claim 1, wherein the user is authorized to perform a pull action to pull the image layer of the container image from the image repository to the local graph but not to perform a push action to push the image layer of the container from the local graph to the image repository and to perform.

6. The computer-implemented method of claim 1, wherein the user is not authorized to perform a push action to push the image layer of the container from the local graph to the image repository, and wherein the user is not authorized to perform a pull action to pull the image layer of the container image from the image repository to the local graph.

7. The computer-implemented method of claim 1, wherein the metadata defines the permissions using a manifest config layer permission identifier.

8. The computer-implemented method of claim 7, wherein the manifest config layer permission identifier is generated by hashing a sum of an image identifier for a layer and a manifest config image layer permission matrix for a user group with which the user is associated.

9. A computer system comprising:
a processor set;
one or more computer-readable storage media; and
program instructions stored on the one or more computer-readable storage media to cause the processor set to perform operations comprising:
receiving a request from a user, the request being one of a first request to push an image layer of a container from a local graph to an image repository or a second request to pull an image layer of a container image from the image repository to the local graph;
identifying permissions associated with the user, the permissions being defined in metadata of a manifest config item of the image layer of the container executing based on the container image;
determining whether the permissions associated with the user authorize the user to perform an action associated with the request; and
responsive to determining that the permissions associated with the user authorize the user to perform the action associated with the request, performing the action, the action being one of pushing the image layer of the container from the local graph to the image repository or pulling the image layer of the container image from the image repository to the local graph.

10. The computer system of claim 9, wherein the operations further comprise, responsive to determining that the permissions associated with the user do not authorize the user to perform the action associated with the request, preventing the action from being performed.

11. The computer system of claim 9, wherein the user is authorized to perform a push action to push the image layer of the container from the local graph to the image repository and to perform a pull action to pull the image layer of the container image from the image repository to the local graph.

12. The computer system of claim 9, wherein the user is authorized to perform a push action to push the image layer of the container from the local graph to the image repository but is not authorized to perform a pull action to pull the image layer of the container image from the image repository to the local graph.

13. The computer system of claim 9, wherein the user is authorized to perform a pull action to pull the image layer of the container image from the image repository to the local graph but not to perform a push action to push the image layer of the container from the local graph to the image repository and to perform.

14. The computer system of claim 9, wherein the user is not authorized to perform a push action to push the image layer of the container from the local graph to the image repository, and wherein the user is not authorized to perform a pull action to pull the image layer of the container image from the image repository to the local graph.

15. The computer system of claim 9, wherein the metadata defines the permissions using a manifest config layer permission identifier.

16. The computer system of claim 15, wherein the manifest config layer permission identifier is generated by hashing a sum of an image identifier for a layer and a manifest config image layer permission matrix for a user group with which the user is associated.

17. A computer program product comprising:
one or more computer-readable storage media; and
program instructions stored on the one or more computer-readable storage media to perform operations comprising:
receiving a request from a user, the request being one of a first request to push an image layer of a container from a local graph to an image repository or a second request to pull an image layer of a container image from the image repository to the local graph;
identifying permissions associated with the user, the permissions being defined in metadata of a manifest config item of the image layer of the container executing based on the container image;
determining whether the permissions associated with the user authorize the user to perform an action associated with the request; and
responsive to determining that the permissions associated with the user authorize the user to perform the action associated with the request, performing the action, the action being one of pushing the image layer of the container from the local graph to the image repository or pulling the image layer of the container image from the image repository to the local graph.

18. The computer program product of claim 17, wherein the operations further comprise, responsive to determining that the permissions associated with the user do not authorize the user to perform the action associated with the request, preventing the action from being performed.

19. The computer program product of claim 17, wherein the user is authorized to perform a push action to push the image layer of the container from the local graph to the image repository and to perform a pull action to pull the image layer of the container image from the image repository to the local graph.

20. The computer program product of claim 17, wherein the user is authorized to perform a push action to push the image layer of the container from the local graph to the image repository but is not authorized to perform a pull action to pull the image layer of the container image from the image repository to the local graph.
